(19) United States
(12) Patent Application Publication
(10) Pub. No.: US 2021/0307359 A1
(43) Pub. Date: Oct. 7, 2021

(54) IMPROVED ANIMAL FEED PRODUCT

(71) Applicant: FermentationExperts A/S, Bække (DK)

(72) Inventors: Jens Høffner Legarth, Bække (DK); Søren Kjærulff, Holte (DK)

(21) Appl. No.: 17/269,150

(22) PCT Filed: Aug. 19, 2019
(86) PCT No.: PCT/EP2019/072160

§ 371 Date: Feb. 17, 2021

(30) Foreign Application Priority Data
Aug. 20, 2018 (DK) PA 2018 00478
Apr. 6, 2019 (DK) PA 2019 00427

(51) Int. Cl. A23K 10/12; A23K 10/30; A23K 10/18; A23K 50/30; A23K 50/60

(52) U.S. Cl. CPC A23K 10/12; A23K 10/30; A23K 50/60; A23K 50/30; A23K 10/18

(57) ABSTRACT

An animal feed product comprising a basic feed compound and a fermented ingredient, wherein the fermented ingredient comprising one or more health-enhancing microorganism and at least one fermented seaweed material; at least one fermented plant material; or a combination of at least one fermented seaweed material and at least one fermented plant material; and wherein the animal feed product comprises a reduced content or no medicinal zinc (Zn) and the fermented ingredient is a dried fermented ingredient, and wherein a range of 20-80% (w/w) of the dry fermented ingredient has a particle size below 0.5 mm (preferably in the range of 0.01-0.5 mm), and wherein 20-80% (w/w) of the dry fermented ingredient comprises a particle size above 0.5 mm (preferably in the range of 0.5-1.0 mm).

### TECHNICAL FIELD OF THE INVENTION

The present invention relates to an improved animal feed product comprising seaweed and/or plant material. In particular the present invention relates to a fermented animal feed product comprising seaweed and/or plant material comprising a reduce amount of medicinal zinc.

### BACKGROUND OF THE INVENTION

For years medicinal zinc (pharmaceutical zinc), in the form of zinc oxide, has been added to animal feed to provide anti-bacterial and anti-inflammatory and anti-bacterial activity.

In particular, medicinal or prescription zinc is added in diets formulated for young animals, specifically as a preventive of diarrhoea. Specially in weaned piglets where the typical inclusion level is about 2500 ppm or 2500 mg/kg feed.

Even medicinal zinc has shown to prevent or reduce the use of antibiotics as drugs to treat sick animals, however, the mode of action of medicinal zinc is not well understood. It has been suggested that such high inclusions of zinc produce a systemic effect in plasma that in turn can interfere with the secretion of chlorine by the epithelial enterocytes in the small intestine, a key mechanism causing diarrhea. Alternatively, it has also been suggested that zinc could boost immune functions and improve the gut mucosa permeability barrier. Altogether, improving resistance towards pathogenic bacteria. Nonetheless, zinc alone has antibacterial effects.

Despite the beneficial effects of medicinal zinc, as an important alternative to the use of antibiotics against diarrhoea in piglets, there also is a concern that high zinc intakes may compete for absorption with other micronutrients such as iron and calcium as well as a negative effect on the environment. This, in turn, can have unintended negative consequences for the piglets health and development.

The European Medicines Agency's Committee on Veterinary Medicinal Products has decided that the benefits of ZnO, e.g. for the prevention of diarrhea in pigs, do not outweigh the risks to the environment. Therefore, the European Union has decided that in 2022 it is prohibited to add medicinal zinc to animal feed, in particular to farm animal feed.

Therefore, there is a need in the animal feed industry for an alternative feed product, which has high antibiotic effect, improved nutritional effect to the consuming animal and at the same time has low impact on the environment.

Hence, an improved animal feed product would be advantageous, and in particular a more efficient and/or reliable animal feed product would be advantageous, which has a strong antibiotic effect, an improved nutritional effect to the consuming animal and a low influence on the environment.

### SUMMARY OF THE INVENTION

Thus, an object of the present invention relates to an improved animal feed product comprising a seaweed material and/or a plant material having a reduced level of medicinal zinc.

In particular, it is an object of the present invention to provide an improved animal feed product comprising a seaweed material and/or a plant material having a reduced level of medicinal zinc that solves the above mentioned problems of the prior art with environmental load and reduced nutritional effect.

Thus, one aspect of the invention relates to an animal feed product comprising a basic feed compound and a fermented ingredient, wherein the fermented ingredient comprising one or more health-enhancing microorganism and:
(i) at least one fermented seaweed material;
(ii) at least one fermented plant material; or
(iii) a combination of at least one fermented seaweed material and at least one fermented plant material; and
   wherein the animal feed product comprises a reduced content or no medicinal zinc (Zn) and the fermented ingredient is a dried fermented ingredient, and wherein a range of 20-80% (w/w) of the dry fermented ingredient has a particle size below 0.5 mm (preferably in the range of 0.01-0.5 mm), and wherein 20-80% (w/w) of the dry fermented ingredient comprises a particle size above 0.5 mm (preferably in the range of 0.5-1.0 mm).

Another aspect of the present invention relates to use of an animal feed product according to the present invention to increase the nutritional effect and/or nutritional uptake of a consuming animal.

The present invention will now be described in more detail in the following.

### DETAILED DESCRIPTION OF THE INVENTION

Accordingly, as addition of medicinal zinc are considered being a lager thread to the environment compared to the positive anti-microbial effect observed in the intestines of the consuming animal, the animal feed industry is faced with a challenge in having addition of medicinal zinc banned from animal feed as of 2020. Surprisingly, the inventors of the present invention found a feed composition which had a reduced content of medicinal zinc, or even no addition of medicinal zinc. In addition to avoiding the environmental disadvantages of using medicinal zinc, the inventors of the present invention surprisingly found that the animal feed product according to the present invention showed to have an improved nutritional effect to the consuming animal. The inventors of the present invention found that improved nutritional effect of an animal feed product may be provided by a proper balance between digestibility and stimulation of intestinal microbiota and stimulation of intestinal mucosa. This improved nutritional effect is provided by the present invention.

A preferred embodiment of the present invention relates to an animal feed product comprising a basic feed compound and a fermented ingredient, wherein the fermented ingredient comprising one or more health-enhancing microorganism and:
(i) at least one fermented seaweed material;
(ii) at least one fermented plant material; or
(iii) a combination of at least one fermented seaweed material and at least one fermented plant material; and
   wherein the animal feed product comprises a reduced content or no medicinal zinc (Zn).

In a preferred embodiment of the present invention the fermented ingredient may be a dried fermented ingredient, and wherein a range of 20-80% (w/w) of the dry fermented ingredient has a particle size below 0.5 mm (preferably in the range of 0.01-0.5 mm), and wherein 20-80% (w/w) of the dry fermented ingredient comprises a particle size above 0.5 mm (preferably in the range of 0.5-1.0 mm).

In the context of the present invention, the term “animal feed product” relates to a substance to be consumed by an animal.

In an embodiment of the present invention, the animal feed product may be a farm animal feed product or a pet food product.

Preferably, the farm animal feed product may be a pig feed product (such as a sow feed product and/or a piglet feed product), a broiler feed product, a roaster feed product, a chickens feed product, a lying hens feed product, a turkey feed product, a duck feed product, a goose feed product, quails feed product, a cattle feed product, a sheep feed product, a goat feed product, or a fish feed product. Even more preferably, the farm animal feed product is a pig feed product or a fish feed product.

In an embodiment of the present invention, the pet food product may be a horses feed product, a dog feed product, or a cat feed product.

In the context of the present invention, the term “medicinal zinc” relates to a zinc containing compound being the product of intentional human manufacture, rather than occurring naturally through processes not involving or requiring direct human activity.

In an embodiment of the present invention, the content of artificial zinc is below 2000 ppm, preferably below 1500 ppm, even more preferably below 1000 ppm, even more preferably below 500 ppm, even more preferably below 100 ppm, even more preferably below 50 ppm, most preferably no artificial zinc.

Zinc is important for proper animal function, and development as zinc deficiency may lead to growth retardation; disorders in bone and joint, as well as feathers and coat, skin diseases, and a low rate of fertility, artificial zinc has been added to animal feed product for years mainly to provide anti-microbial effects for the consuming animals, e.g. avoiding bacterial infections, such as infections resulting in diarrhoea. Some studies also show that using zinc oxide has been associated with the occurrence of methicillin-resistant Staphylococcus aureus as the resistant bacteria might carry zinc-resistance genes, as well as certain antimicrobial effects are suspected.

The application of zinc oxide is considered a key alternative to the reduction of antibiotics usage. The European Commission, however, has pointed to zinc oxide having a serious impact on the environment as much of the substance gets excreted and ends up in fields when the manure is applied on the lands.

In an embodiment of the present invention, the medicinal zinc may be an inorganic zinc compound.

In another embodiment of the present invention, medicinal zinc (or pharmaceutical zinc) may be zinc oxide.

In the event medicinal zinc is added to the animal feed product according to the present invention, the medicinal zinc may be in the form of nano-particles.

In the context of the present invention, the term “comprising”, which may be synonymous with the terms “including”, “containing” or “characterized by”, relates to an inclusive or open-ended listing of features and does not exclude additional, unrecited features or method steps. The term “comprising” leaves the claim open for the inclusion of unspecified ingredients even in major amounts.

In a preferred embodiment of the present fermented invention the ingredient may consisting essentially of one or more health-enhancing microorganism and:
(i) at least one fermented seaweed material;
(ii) at least one fermented plant material; or
(iii) a combination of at least one fermented seaweed material and at least one fermented plant material.

In the context of the present invention, the term “consisting essentially of”, relates to a limitation of the scope of a claim to the specified features or steps and those features or steps, not mentioned and that do not materially affect the basic and novel characteristic(s) of the claimed invention.

In an embodiment of the present invention, the fermented ingredient may represent in the range of 0.5-50% (w/w) of the animal feed product, such as in the range of 1-45% (w/w), e.g. in the range of 2-40% (w/w), such as in the range of 3-35% (w/w), e.g. in the range of 4-30% (w/w), such as in the range of 5-25% (w/w), e.g. in the range of 7.5-20% (w/w), such as in the range of 10-15% (w/w).

The animal feed product according to the present invention comprises the combination of a basic feed compound and a fermented ingredient.

Preferably, the basic feed compound may be a basic feedstuff product or a basic forage product.

In an embodiment of the present invention the basic feedstuff product may comprise a feed protein and a premix.

Premixes may be composed of micro-ingredients such as vitamins, minerals, chemical preservatives, antibiotics, fermentation products, oils, amino acids, and other essential ingredients

In an embodiment of the present invention the feed protein comprises one or more cereals, one or more vegetable protein, one or more dried distillers grains with soluble protein, one or more animal protein, or a combination hereof

Preferably, the one or more cereals may be selected from the group consisting of corn, triticale, alfalfa, sorghum, oats, wheat, rye, and barley or fractions hereof;

Preferably, the one or more vegetable protein, wherein the one or more vegetable protein is selected from the group consisting of soybean meal, sunflower meal, rapeseed meal, cassava meal, copra meal, rice meal, peas, and lupins;

Dried distillers grains with soluble protein (DDGS) may be selected from corn-DDGS and/or wheat-DDGS;

Preferably, the animal protein may be selected from the groups consisting of fish meal, meat and bones meal, feather meal, poultry by-product, blood meal.

The animal feed product may further comprise a lipid component. Preferably the lipid component comprises Tallow, soy oil, tallow-soy blend, poultry fat, and/or palm oil.

In an embodiment of the present invention, the animal feed product according to the present invention may further comprises a potato pulp.

In a further embodiment of the present invention the feed protein may be the dominating ingredient in the basic feed compound.

In yet an embodiment of the present invention the animal feed product is a farm animal feed product comprising 25-35% protein 60-70% cereal and a premix, all ingredients are on a dry matter basis.

In another embodiment of the present invention the animal feed product is a pet food comprising 60-90% protein on a dry matter basis. In a further embodiment of the present invention the animal feed product is a pet food comprising 20-50% protein and 60-70% cereal and a premix, all ingredients are on a dry matter basis.

The term “at least one fermented seaweed material” implies that different fermented seaweed materials may be used. In an embodiment of the present invention the animal feed product comprises at least one seaweed material, such as at least two seaweed materials, e.g. at least three seaweed materials, such as at least four seaweed materials.

In an embodiment of the present invention, wherein the at least one fermented seaweed material may be a unicellular alga or a multicellular macroalgae.

In a further embodiment of the present invention, the multicellular macroalgae may be selected from brown macroalgae, red macroalgae, and/or green macroalgae.

In another embodiment of the present invention, the brown macroalgae may be selected from one or more of kelps, Saccharina latissima (Laminaria saccharina), Laminaria digitate, Ascophyllum nodosum, Laminaria hyperborean, or a mixture hereof.

In the present context, the term “plant material” relates to a material capable of performing photosynthesis.

The term “at least one fermented plant material” implies that different plant materials may be used. In an embodiment of the present invention the animal feed product comprises at least one fermented plant material, such as at least two fermented plant materials, e.g. at least three fermented plant materials, such as at least four fermented plant materials.

When the animal feed product comprises two or more fermented plant materials, the fermented plant materials may be of different origin.

In an embodiment of the present invention, the fermented plant material may be selected from at least one proteinaceous plant material. The proteinaceous plant material may be a vegetable plant material, preferably, the vegetable plant material may be selected from eudicot plants, angiosperm plants, and/or rosid plants.

Preferably the proteinaceous plant material or the vegetable plant material may be selected from Brassicale plants.

In an embodiment of the present invention the Brassicale plants is selected from the Brassicaceae family or the Cruciferae family.

In a further embodiment of the present invention, the Brassicaceae family or the Cruciferae family may be selected from at least one of a Brassica genus; sun flower; palm; soya, field beans, lupins; or a combination hereof. Preferably, at least one Brassica genus may be selected from one or more species such as Brassica napus; Brassica oleracea; Brassica campestris; Brassica nigra; Sinapis alba (Brassica alba); Brassica juncea; Brassica rapa or mixtures hereof.

In yet an embodiment of the present invention, the at least one Brassica genus may be selected from the group consisting of: including rape, rapeseed, canola, cabbage, broccoli, cauliflower, kale, Brussels sprouts, collard greens, savoy, kohlrabi, gai Ian, white mustard, Indian mustard, Chinese mustard, and black mustard seed powder.

The animal feed product may comprise a combination of at least one fermented seaweed material as defined above, and at least one fermented plant material as defined above.

In the present context, the term “fermented” relates to a material (at least one plant material, at least one seaweed material or a combination of at least one plant material and at least one seaweed material) relates to a controlled metabolic process of the material(s) by adding a predetermined amount of fermenting microorganisms to the material allowing the microorganism and the material(s) to interact breaking down the material.

The fermented ingredient and the animal feed product comprises one or more health-enhancing microorganism, preferably the health-enhancing microorganism may be a health-enhancing yeast and/or a health-enhancing bacterium, even more preferably the health-enhancing microorganism may be a health-enhancing bacterium.

The health-enhancing bacteria may comprise one or more probiotics. The one or more probiotics and/or the one or more health-enhancing microorganism may comprise at least one lactic acid bacterial strain.

In the context of the present invention, the term “probiotic” relates to live microorganisms that when administered in adequate amounts, confer a health benefit on the host.

In a preferred embodiment of the present invention, the at least one lactic acid bacterial strain may be selected from the group consisting of the genus Enterococcus, Lactobacillus, Pediococcus, Lactococcus, or Bifidobacterium or combinations thereof.

In a further embodiment of the present invention, the one or more lactic acid bacterial stain(s) may be selected from the group consisting of Pediococcus pentosaceus; Pendiococcus acidilactici; Lactobacillus plantarum, Lactobacillus rhamnosus, Enterococcus faecium, Lactobacillus acidophilus, Bifidobacterium lactis, Bifidobacterium longum, Bifidobacterium bifidum, Lactobacillus salivarius, Lactobacillus pentosus, Lactobacillus vaginalis, Lactobacillus xylosus and a combination thereof.

In an embodiment of the present invention, the health-enhancing microorganism may be the main microorganism present in the animal feed product. Preferably, the main microorganism is a lactic acid bacterium. Even more preferably the main microorganism may be selected from the groups consisting of Pediococcus pentosaceus; Pendiococcus acidilactici, Lactobacillus plantarum, Lactobacillus rhamnosus, Enterococcus faecium, Lactobacillus acidophilus, Bifidobacterium lactis, Bifidobacterium longum, Bifidobacterium bifidum, Lactobacillus salivarius, Lactobacillus pentoses, Lactobacillus vaginalis, and Lactobacillus xylosus; preferably, the main lactic acid bacteria present in the composition is Lactobacillus plantarum.

In the context of the present invention, the term “main microorganism” relates to the microorganism present in highest amount, determined on a weight/weight ratio relative to the total number of microorganism present.

During fermentation, a group of microorganisms may be used for fermenting the plant material to provide a co-fermentation. The co-fermentation may be a mixture of different microorganisms (such as a mixture of yeasts, fungus, and/or bacteria) or a mixture of different bacteria. Preferably the co-fermentation comprises a mixture of different bacterial strains. In an embodiment of the present invention the animal feed product comprises one or more bacterial strains, e.g. two or more bacterial strains, such as three or more bacterial strains, e.g. four or more bacterial strains, such as 7 or more bacterial strains, e.g. 10 or more bacterial strains, such as 15 or more bacterial strains, e.g. 20 or more bacterial strains, such as 25 or more bacterial strains, e.g. 30 or more bacterial strains, such as 35 or more bacterial strains, e.g. 40 or more bacterial strains. Preferably, the bacterial strains may be one or more lactic acid bacterial strains.

In a further embodiment of the present invention, the one or more lactic acid bacteria stain(s) may be selected from the group consisting of one or more of Pediococcus pentosaceus (DSM 12834); Pendiococcus acidilactici (DSM 16243); Lactobacillus plantarum (DSM 12837); Enterococcus faecium (NCIMB 30122), Lactobacillus rhamnosus (NCIMB 30121), Pediococcus pentosaceus HTS (LMG P-22549), Pendiococcus acidilactici (NCIMB 30086) and/or Lactobacillus plantarum LSI (NCIMB 30083). Preferably, the one or more lactic acid bacteria stain(s) may be selected from the group consisting of one or more of Pediococcus pentosaceus (DSM 12834); Pendiococcus acidilactici (DSM 16243); Lactobacillus plantarum (DSM 12837).

The animal feed product may have a high content of viable lactic acid bacteria. In an embodiment of the present invention the animal feed product comprises one or more lactic acid bacterial strain(s) in a total amount in the range of 10⁵-10¹² CFU per gram of the animal feed product, such as in the range of 10⁶-10¹² CFU per gram, e.g. in the range of 10²-10¹¹ CFU per gram, such as in the range of 10⁸-10¹¹ CFU per gram, e.g. in the range of 10⁹-10¹⁰ CFU per gram.

The ingredient may have a high content of viable lactic acid bacteria. In an embodiment of the present invention, the ingredient comprises one or more lactic acid bacterial strain(s) in a total amount in the range of 10⁵-10¹² CFU per gram of the animal feed product, such as in the range of 10⁶-10¹² CFU per gram, e.g. in the range of 10⁷-10¹¹ CFU per gram, such as in the range of 10⁸-10¹¹ CFU per gram, e.g. in the range of 10⁹-10¹⁰ CFU per gram.

In an embodiment of the present invention, the animal feed product may comprise a lactic acid concentration of at least 0.05% lactic acid relative to the animal feed product, such as at least 0.1% lactic acid relative to the animal feed product, such as at least 0.5% lactic acid relative to the animal feed product, e.g. at least 0.75% lactic acid relative to the animal feed product, such as at least 1% lactic acid relative to the animal feed product, e.g. at least 2.5% lactic acid relative to the animal feed product, at least 5% lactic acid relative to the animal feed product, such as in the range of 0.05-5% lactic acid relative to the animal feed product, such as in the range of 0.1-2.5% lactic acid relative to the animal feed product, such as in the range of 0.5-1% lactic acid relative to the animal feed product.

During fermentation, various metabolites may be formed, which in combination, may assist in the enhancing the nutritional and antibiotic benefits from using the ingredient according to the present invention in the animal feed product.

When the ingredient or the animal feed product comprises the combination of at least one fermented plant material and at least one fermented seaweed material, the fermentation of the at least one plant material and the fermentation of the at least one seaweed material may be performed separately or jointly. Preferably, the fermentation of the at least one plant material and the fermentation of the at least one seaweed material may be performed jointly. Further details on the fermentation procedure may be found in WO 2014/206419, which is hereby incorporated by reference.

In an embodiment of the present invention the fermentation process for providing the at least one fermented plant material; the at least one fermented seaweed; or the combination of the at least one fermented plant material and the at least one fermented seaweed material (fermented separately or jointly) may be performed for a period in the range of 24 hours to 30 days, such as for a period in the range of 2-25 days, e.g. for a period in the range of 5-20 days, such as for a period in the range of 7-15 days, e.g. for a period in the range of 10-13 days, e.g. about 11 days.

If fermentation is performed jointly with the plant material and the seaweed material, the fermentation of the seaweed material may be started first and the plant material may be added subsequently. In an embodiment of the present invention the seaweed material may be subjected to fermentation for 1-15 days before the plant material is added; such as 3-12; e.g. 5-10; such as about 7 days before the plant material is added. When the plant material is added to the fermented plant material the fermentation may be continued with both the seaweed and the plant material for 2-20 days; such as for 4-16 days; e.g. for 8-13 days; e.g. for about 11 days.

In a further embodiment of the present invention the fermentation process for providing the at least one fermented plant material; the at least one fermented seaweed; or the combination of the at least one fermented plant material and the at least one fermented seaweed material (fermented separately or jointly) may be performed at a temperature in the range of 25-45° C.; such as in the range of 30-43° C.; e.g. in the range of 32-40° C., such as about 35° C.

During fermentation the pH of the material fermented may preferably drop within the first 24 hours of fermentation to pH 6 or below, such as pH 5 or below, e.g. pH 4.5 or below, such as pH 4.2 or below. Preferably, the drop in pH may be provided by the fermentation process, preferably no addition of acid may be made.

The animal feed product according to the present invention may preferably comprises a fibrous material. Preferably the animal feed product comprises the fibrous material originating from the plant material and/or the seaweed material.

In an embodiment of the present invention, the animal feed product comprises more than 5 g fibrous material per kg dried animal feed product, such as more than 10 g fibrous material per kg dried animal feed product, e.g. more than 15 g fibrous material per kg dried animal feed product, such as more than 20 g fibrous material per kg dried animal feed product, e.g. more than 25 g fibrous material per kg dried animal feed product, such as more than 50 g fibrous material per kg dried animal feed product, e.g. more than 75 g fibrous material per kg dried animal feed product, such as more than 100 g fibrous material per kg dried animal feed product, e.g. more than 150 g fibrous material per kg dried animal feed product, such as more than 200 g fibrous material per kg dried animal feed product, e.g. more than 250 g fibrous material per kg dried animal feed product, such as more than 300 g fibrous material per kg dried animal feed product.

The animal feed product according to the present invention may preferably comprises a starch material. Preferably the animal feed product comprises the starch material originating from the plant material and/or the seaweed material.

In an embodiment of the present invention, wherein the composition may comprise more than 5 g starch material per kg dried composition, such as more than 10 g starch material per kg dried composition, e.g. more than 15 g starch material per kg dried composition, such as more than 20 g starch material per kg dried composition, e.g. more than 25 g starch material per kg dried composition, such as more than 50 g starch material per kg dried composition, e.g. more than 75 g starch material per kg dried composition, such as more than 100 g starch material per kg dried composition, e.g. more than 150 g starch material per kg dried composition, such as more than 200 g starch material per kg dried composition, e.g. more than 250 g starch material per kg dried composition, such as more than 300 g starch material per kg dried composition.

It may be preferred that the animal feed product according to the present invention may be a dried composition. Preferably having a moisture content of 15% (w/w) or less, such as less than 12.5% (w/w), e.g. less than 10% (w/w), such as less than 7.5% (w/w), e.g. less than 5% (w/w).

At least one plant material and/or the at least one seaweed material may have an average maximum diameter of 5 cm, such as an average maximum diameter of 4 cm such as an average maximum diameter of 3 cm, such as an average maximum diameter of 2 cm, such as an average maximum diameter of 1 cm, such as an average diameter in the range 25 μm to 5 cm, such as 0.1 mm to 5 cm, such as an average diameter in the range of 0.5 mm to 5 cm, such as an average diameter in the range 0.5 mm to 2 cm.

In an embodiment of the present invention the at least one plant material and/or the at least one seaweed material may subjected to at least one pre-treatment of the at least one plant material and/or the at least one seaweed material resulting in the above mentioned average maximum diameter.

The at least one pre-treatment may involve disintegration, chopping, sheading, crushing, grinding, or the like of the at least one plant material and/or the at least one seaweed material, in order to reduce the size of the at least one plant material and/or the at least one seaweed material.

In an embodiment of the present invention the pre-treatment may be performed on at least one dried, fresh or frozen plant material and/or on at least one dried, fresh or frozen seaweed material.

The animal feed product according to the present invention, may comprise a content of the ingredient in the range of 0.5-25% (w/w), such as in the range of 1-20% (w/w), e.g. in the range of 2-18% (w/w), such as in the range of 3-16% (w/w), e.g. in the range of 5-15% (w/w), such as in the range of 7-12% (w/w), e.g. in the range of 8-10% (w/w).

The fermented seaweed material and/or the fermented plant material, may preferably not be subjected to sterilisation in order to maintain the native metabolic nature of the materials.

Conditions for providing and fermenting the fermented seaweed material; the fermented plant material, or the combination of fermented seaweed material and fermented plant material, may be as described in WO 2008/006382; WO 2014/206419; or PCT/EP2016/076952. WO 2008/006382; WO 2014/206419; or PCT/EP2016/076952 are hereby incorporated by reference.

The animal feed product according to the present invention may preferably induce an increased nutritional effect and/or nutritional uptake of a consuming animal.

The inventors of the present invention found that the best nutritional effect was obtained from providing a balance between digestibility of the fermented ingredient and stimulation of the intestinal microbiota and/or stimulation of the intestinal mucosa.

In order to meet this balance different fractions of particle sizes of the fermented ingredient may be provided.

In an embodiment of the present invention the fermented ingredient may be a dried fermented ingredient. The drying of the fermented ingredient may preferably be a gentle drying method in order to maintain the active potential of the fermented ingredient. An example of a gentle drying method may be as described in WO 2013/029632.

The fermented ingredient may be mixed with the basic feed compound as a free-flowing powder or before animal feed pellets are formed, resulting in animal feed pellets comprising the fermented ingredient. Preferably the fermented ingredient is mixed with the basic feed compound as a dry fermented ingredient.

In an embodiment of the present invention the dried fermented ingredient comprises a range of 30-70% (w/w); such as a range of 40-60% (w/w); e.g. about 50% (w/w) of the dry fermented ingredient has a particle size below 0.5 mm and a range of 30-70% (w/w); such as a range of 40-60% (w/w); e.g. about 50% (w/w) of the dry fermented ingredient has a particle size above 0.5 mm.

In aa further embodiment of the present invention the dried fermented ingredient comprises at least 2, preferably at least 3, even more preferably at least 4 of the following criteria:
a) 1-10% (w/w), such as about 5% (w/w), of the dry fermented ingredient has a particle size above 1.0 mm;
b) 45-55% (w/w), such as about 50% (w/w), of the dry fermented ingredient has a particle size between 0.5-1.0 mm;
c) 30-40% (w/w), such as about 50% (w/w), of the dry fermented ingredient has a particle size between 0.25-0.5 mm; and/or
d) 5-15% (w/w), such as about 10% (w/w), of the dry fermented ingredient has a particle size below 0.25 mm.

In the present context the term “about” relates to a variation on the stated amount of 10% or less, such as 5% or less, e.g. 1% or less.

The selection of the various particle sizes may be determined by sieving as known to the skilled person.

Thus, the animal feed product may be used in a method for improving or increasing the nutritional effect and/or nutritional uptake of a animal.

When feed is consumed, it becomes degraded through the digestive system and in the intestine, nutrient ingredients from the feed may be absorbed into the body.

Intestinal villi are small, finger-like projections that extend into the lumen of the small intestine. Each villus has many microvilli projecting from the enterocytes of its epithelium which collectively form the striated or brush border.

Intestinal villi and furthermore microvilli increases the internal surface area of the intestinal walls making available a greater surface area for absorption of the nutrients from the digested feed. An increased absorptive area is useful because digested nutrients (including monosaccharide, amino acids, small peptides, lipids and iron) pass into the semipermeable villi specific enzyme carriers located at the brush border, and becomes adsorbed by the body.

In an embodiment of the present invention, the animal feed product according to the present invention may increase the height/length of the intestinal villi by at least 5%, such as at least 10%, e.g. at least 15%, such as at least 20%, e.g. at least 25%, such as at least 30%, e.g. at least 35%, such as at least 40%, e.g. at least 45%, such as at least 50%, e.g. at least 60%, such as at least 75%.

In another embodiment of the present invention, the animal feed product according to the present invention may increase the height/length of the intestinal microvilli by at least 5%, such as at least 10%, e.g. at least 15%, such as at least 20%, e.g. at least 25%, such as at least 30%, e.g. at least 35%, such as at least 40%, e.g. at least 45%, such as at least 50%, e.g. at least 60%, such as at least 75%.

Not only the intestinal villi or intestinal microvilli are increased in height from feeding an animal with the animal feed product according to the present invention, but also the intestinal enterocytes are increased in height.

In an embodiment of the present invention, the animal feed product according to the present invention may increase the height/length of the intestinal enterocytes by at least 5%, such as at least 10%, e.g. at least 15%, such as at least 20%, e.g. at least 25%, such as at least 30%, e.g. at least 35%, such as at least 40%, e.g. at least 45%, such as at least 50%, e.g. at least 60%, such as at least 75%.

In a further embodiment of the present invention a method is provided for improving the feed conversion rate of an animal, wherein the method comprises the step of administering an animal feed product according to the present invention to an animal.

It should be noted that embodiments and features described in the context of one of the aspects of the present invention also apply to the other aspects of the invention.

All patent and non-patent references cited in the present application, are hereby incorporated by reference in their entirety.

The invention will now be described in further details in the following non-limiting examples.

### EXAMPLES

### Example 1

Determining the effect of the animal feed product according to the present invention on feed conversion rate, nutritional uptake and incidence of diarrhoea.

### Method

The experiments were conducted at a private, commercial farm and included:
1350 sows.
33.5 weaned piglets per sow annually.
440 gram per day on average daily gain in weaner unit (exit weight: ˜33 kg).
Feeding was performed using 4 different dietary treatment groups (TG) all groups were mash feed.
Litters were standardized to 14 piglets per sow; fixed from day 14 post-partum.
Differential feeding
   start: 10 days before weaning; end: at exit from weaner unit.
   The animal was followed until slaughter (˜115 kg).
No systemic or individual antibiotics treatment of experimental pigs was done.
   Piglets needing treatment were eliminated from the experiment and treated elsewhere.
15 days after weaning, 6 piglets/TG were slaughtered and blood and intestines were analysed.

The following 4 different treatment groups (TG) each comprising 50 piglets were provided:
TG1: No supplementation (negative control)
TG2: 2500 ppm zinc oxide (positive control)
TG3: 8% of DM as prefermented rape seed
TG4: 10% of DM as prefermented rape seed

Supplements were mixed into the standard pre-weaner and starter diets.

Statistical analyses were performed including TG, gender and their interactions, start weight.

### Results

The results demonstrate that the feed according to the present invention resulted in an increased feed conversion rate, increased nutritional uptake and a reduced incidence of diarrhoea.

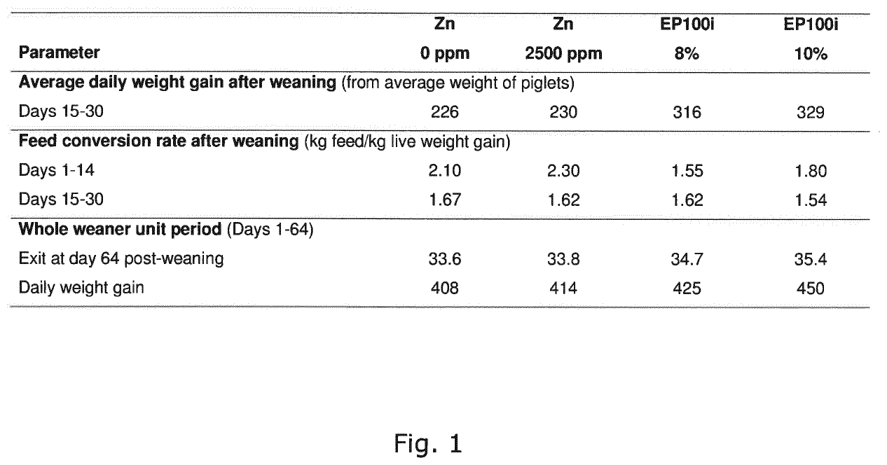

FIG. 1 illustrates an increased average daily weight gain after weaning for pigs of 15-30 days old piglets. The results show that by adding 8% fermented rape seed (EP100i) to the animal feed product or ingredient according to the present invention, the average daily weight gain after weaning for pigs of 15-30 days old piglets was increased 40% relative to feed products not supplemented with medicinal zinc and 37% relative to feed products supplemented with 2500 ppm medicinal zinc. FIG. 1 illustrate that increasing the concentration of fermented rape seed (EP100i) to 10% the average daily weight gain after weaning for pigs of 15-30 days old piglets was further increased to 46% relative to feed products not supplemented with medicinal zinc and 43% relative to feed products supplemented with 2500 ppm medicinal zinc.

It is further illustrated in FIG. 1, that the feed conversion rate after weaning (kg feed/kg live weight gain) was increased for piglets (divided in groups 1-14 days of age and 15-30 days of age) receiving the animal feed supplemented with 8% fermented rape seed according to the present invention. FIG. 1 show a significant increase in the feed conversion rate for piglets of 1-14 days of age 26% relative to feed products not supplemented with medicinal zinc and 33% relative to feed products supplemented with 2500 ppm medicinal zinc, whereas piglets of 15-30 days of age only an increase of 3% relative to feed products not supplemented with medicinal zinc was observed and no inncreased was observed relative to feed products supplemented with 2500 ppm medicinal zinc. Increasing the concentration of fermented rape seed (EP100i) to 10% the feed conversion rate for pigs of 1-14 days of age and 15-30 days of age, was also increased for both feed products not supplemented with medicinal zinc and for feed products supplemented with 2500 ppm medicinal zinc.

From FIG. 1 it is shown that an increased weight at exit from the weaner unit (91 days of age/64 post weaning) was approximately 1-1.7 kg higher for piglets receiving the animal feed product according to the present invention relative to feed products not supplemented with medicinal zinc and relative to feed products supplemented with 2500 ppm medicinal zinc, as well as an increased daily weight gain was observed for piglets receiving the animal feed product according to the present invention relative to feed products not supplemented with medicinal zinc and relative to feed products supplemented with 2500 ppm medicinal zinc.

Thus, FIG. 1 clearly illustrates an improved feed conversion rate and an improved nutritional uptake for piglets receiving the animal feed product according to the present invention relative to feed products not supplemented with medicinal zinc and relative to feed products supplemented with 2500 ppm medicinal zinc.

The improved feed conversion rate and the improved nutritional uptake for piglets may be a result of an increase in microvilli height and/or endocyte height.

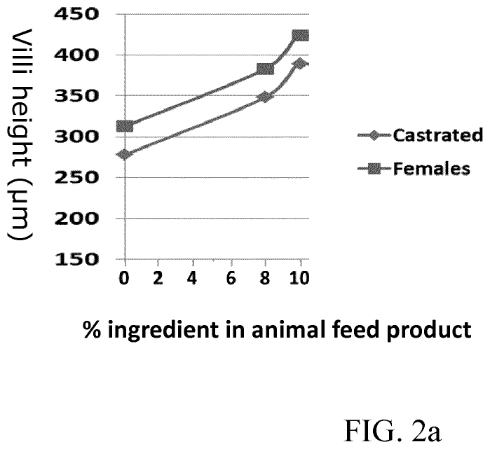

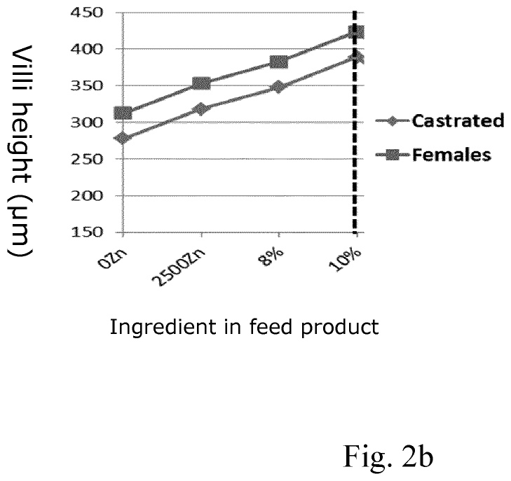

FIG. 2a illustrates the development of villi height, determined in μm, for increasing concentrations of the ingredient in the animal feed product from 0 to 10% ingredient in the animal feed product. The ingredient was based on rapeseed which has been fermented using a mixture of Pediococcus pentosaceus (DSM 12834), Pendiococcus acidilactici (DSM 16243) and/or Lactobacillus plantarum (DSM 12837). FIG. 2b illustrate an increased villi height in piglets receiving animal feed according to the present invention relative to feed products not supplemented with medicinal zinc and relative to feed products supplemented with 2500 ppm medicinal zinc.

The results in FIG. 2 shows that a significant increase in villi height is provided when increasing the amount of ingredient from 0% to 10% whereby the surface area of the intestine for absorbing nutrients are provided whereby the improved feed conversion rate and the improved nutritional uptake for piglets may be provided.

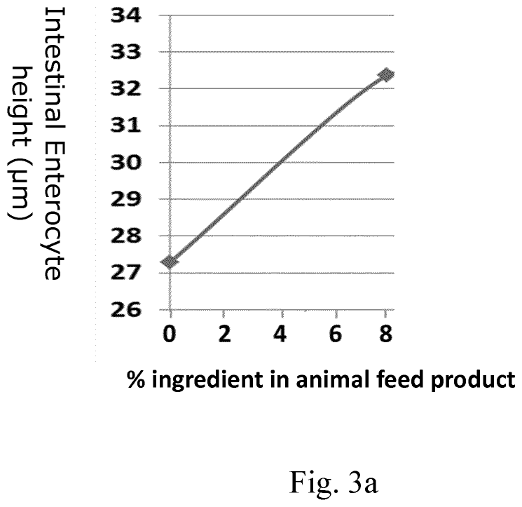

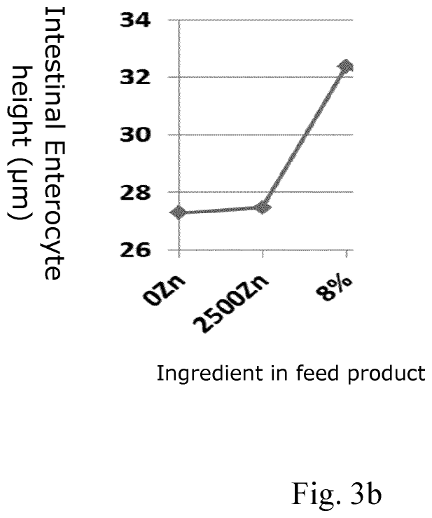

Also an improved intestinal enterocyte height development (determined in μm) are demonstrated for piglets feed with an animal feed product supplemented with the ingredient according to the present invention, see FIG. 3a. The ingredient was based on rapeseed which has been fermented using a mixture of Pediococcus pentosaceus (DSM 12834), Pendiococcus acidilactici (DSM 16243) and/or Lactobacillus plantarum (DSM 12837)

The results presented in FIG. 3a show a significant increase in enterocyte height when increasing the concentration of the ingredient in the animal feed product from 0% to about 8%. FIG. 3b illustrate an increased enterocyte height in piglets receiving animal feed according to the present invention relative to feed products not supplemented with medicinal zinc and relative to feed products supplemented with 2500 ppm medicinal zinc.

Analysing the piglet diarrhoea after weaning showed a reduced incidence of diarrhoea days and shorter duration of diarrhoea infection for piglets receiving the animal feed product according to the present invention, comparted not only to the group not receiving any Zn but also relative to the group receiving 2500 ppm Zn. The effect on diarrhoea (reduced incidence of diarrhoea days and shorter duration of diarrhoea) improved as the amount of active ingredient in the animal feed product was increased.

### IN CONCLUSION

The results clearly illustrate that the animal feed product according to the present invention is a very interesting substitution to the addition of medicinal zinc, since a high antimicrobial activity in controlling diarrhoea in piglets may be provided, and in addition to providing high antimicrobial effect, an increase in the intestinal villi height and the intestinal enterocyte height may also be provided, resulting in an increased internal surface area of the intestinal walls available for absorption of the nutrients from the digested feed as well as an increased nutritional uptake resulting in increased weight gain.

### Example 2

An example similar to the example above was made, except that the animal feed was supplemented with a mixture of plant material (rapeseed meal, Brassica napus), and seaweed, Saccharina latisima/Ascophylum nodosum).

### Fermentation Procedure

The plant material and the seaweed were fermented via a 2-step solid state fermentation, using an inoculum consisting of three lactic-acid fermentative bacteria (Pediococcus acidilactici-DSM 16243, Pediococcus pentosaceus-DSM 12834, Lactobacillus plantarum-DSM 12837) to control the fermentation process, the fermentation process may be further described in WO 2014/206419, which is hereby incorporated by reference.

The addition of the inoculant controls the process by acidifying the blend to a pH 4.2 within the first 24 hours, providing an almost entire anaerobic process. The process runs for 11 days at 35° C. The fermented material is then dried in a spin flash dryer, with a temperature setting and pass-through-speed that preserves the viable bacteria and the microbial temperature-labile bioactive metabolites. The drying process is described in WO 2013/029632, which is hereby incorporated by reference.

### Feeding Procedure

This study was carried out at a commercial farm in Poland in 2018. In total, 666 eighteen-day-old piglets were tested under three feeding regimes. The following 3 different treatment groups (TG) were prepared:
TG 5: A commercial basal diet with no supplementation (negative control)
TG 6: A commercial basal diet, supplemented with 2500 ppm zinc oxide (positive control)
TG 7: A commercial basal diet, supplemented with 10% of the above fermented plant material and the seaweed

Animals were given the diets in separate groups, 10 days prior to weaning (at day 18 post farrowing) and until day 63 when piglets exited the nursing cage (at day 92 post farrowing). Piglets of each diet regime were housed in nursing pens holding an average of 48 animals per treatment. Each diet treatment was repeated 5 times and the control was repeated 4 times. The different pens were distributed and tagged accordingly in the nursing blocks at the farm.

None of the diets included growth promoter or antibiotics. Furthermore, piglets were not given administered antibiotics when presenting diarrhea at any point during the experiment. Animals that presented diarrhea were left in the pen untreated and allowed to recover by themselves, unless falling ill. Then they were removed from the experiment and treated by a veterinary.

The diets and fresh water were supplied ad libitum.

### Results and Discussion

In the same way as illustrated above in Example 1, with a feed supplemented with rapeseed alone, the results in the present Example 2 with the mixture of plant material (rapeseed meal, Brassica napus), and seaweed, Saccharina latisima/Ascophylum nodosum) also show to be a very interesting alternative and substitution to the addition of medicinal zinc, since a high antimicrobial activity in controlling diarrhoea in piglets is provided, as well as an increased intestinal villi height and intestinal enterocyte height are also be provided, resulting in an increased internal surface area of the intestinal walls available for absorption of the nutrients from the digested feed as well as an increased nutritional uptake resulting in increased weight gain.

Furthermore, the mucous membrane was higher in the TG 7 group (diet supplemented with mixture of plant material and seaweed) with significantly deeper intestinal crypts than in the TG 5 group (diet with no supplementation) and the TG 6 group (diet supplemented with zinc oxide).

Also the hindgut bacterial diversity was evaluated via 16S rRNA variable regions analysis and showed a significant decrease in the presence of the dominating Bacterioides fiber-associated Prevotella spp. whereas other other bacterial groups like, Lactobacillus spp, Ruminococcaceae spp., and the Clostridiales group increased significantly, compared to both the TG 5 group (diet with no supplementation) and the TG 6 group (diet supplemented with zinc oxide).

### Example 3

### Effect of the Particle Size Distribution.

The following 4 different treatment groups (TG) each comprising 25 piglets were provided with one of the following:
TG8: 10% of DM as prefermented dried rape seed
TG9: 8% of DM as prefermented dried rape seed+2% of DM as prefermented dried seaweed
TG10: 10% of DM as prefermented dried rape seed
TG11: 8% of DM as prefermented dried rape seed+2% of DM as prefermented dried seaweed

Ingredient TG 8 and TG 9 were mixed directly into the standard pre-weaner and starter diets.

Ingredients TG 10 and TG 11 were subjected to gentle grinding before they were mixed into the standard pre-weaner and starter diets. The resulting ground ingredients 7 and 8 has a particle size distribution where 50% (w/w) of the dried fermented ingredient has a particle size in the range of 0.01-0.5 mm, and 50% (w/w) of the dry fermented ingredient comprises a particle size in the range of 0.5-1.0 mm.

Feeding was done in the same way as described in Example 1.

### Results

The results demonstrate that the digestibility of the feed product was significantly improved in the treatment groups 10 and 11 compared to the treatment group 8 and 9. This significant improvement may be caused by the smaller sized ingredients provided in treatment groups 10 and 11 where the digestive system in the pigs/piglet has a better access the to the material. Despite the treatment if ingredients 10 and 11, the results demonstrate a slight improvement in the nutritional uptake in treatment groups 10 and 11 compared to treatment groups 8 and 9.

The nutritional value per kg diet feed in treatment groups 10 and 11 compared to treatment groups 8 and 9 was calculated to 8% for treatment group 10 (compared to treatment group 8) and 10% for treatment group 11 (compared to treatment group 9).

### REFERENCES

WO 2008/006382
WO 2014/206419
PCT/EP2016/076952
WO 2013/029632

1. An animal feed product comprising a basic feed compound and a fermented ingredient, wherein the fermented ingredient comprising one or more health-enhancing microorganism and:
(i) at least one fermented seaweed material;
(ii) at least one fermented plant material; or
(iii) a combination of at least one fermented seaweed material and at least one fermented plant material; and
wherein the animal feed product comprises a reduced content or no medicinal zinc (Zn) and the fermented ingredient is a dried fermented ingredient, and wherein a range of 20-80% (w/w) of the dry fermented ingredient has a particle size below 0.5 mm (preferably in the range of 0.01-0.5 mm), and wherein 20-80% (w/w) of the dry fermented ingredient comprises a particle size above 0.5 mm (preferably in the range of 0.5-1.0 mm) wherein the animal feed product is a pig feed product.

2. The animal feed product according to claim 1, wherein the content of artificial zinc is below 2000 ppm, preferably below 1500 ppm, even more preferably below 1000 ppm, even more preferably below 500 ppm, even more preferably below 100 ppm, even more preferably below 50 ppm, most preferably no artificial zinc.

3. The animal feed product according to claim 1, wherein the dried fermented ingredient comprises a range of 30-70% (w/w); such as a range of 40-60% (w/w); e.g. about 50% (w/w) of the dry fermented ingredient has a particle size below 0.5 mm and a range of 30-70% (w/w); such as a range of 40-60% (w/w); e.g. about 50% (w/w) of the dry fermented ingredient has a particle size above 0.5 mm.

4. The animal feed product according to claim 1, wherein the dried fermented ingredient comprises at least 2, preferably at least 3, even more preferably at least 4 of the following criteria:
a) 1-10% (w/w), such as about 5% (w/w), of the dry fermented ingredient has a particle size above 1.0 mm;
b) 45-55% (w/w), such as about 50% (w/w), of the dry fermented ingredient has a particle size between 0.5-1.0 mm;
c) 30-40% (w/w), such as about 50% (w/w), of the dry fermented ingredient has a particle size between 0.25-0.5 mm; and/or
d) 5-15% (w/w), such as about 10% (w/w), of the dry fermented ingredient has a particle size below 0.25 mm.

5. (canceled)

6. The animal feed product according to claim 1, wherein the pig feed product is a sow feed product and/or a piglet feed product.

7. The animal feed product according to claim 1, wherein the fermented ingredient represents in the range of 0.5-50% (w/w) of the animal feed product, such as in the range of 1-45% (w/w), e.g. in the range of 2-40% (w/w), such as in the range of 3-35% (w/w), e.g. in the range of 4-30% (w/w), such as in the range of 5-25% (w/w), e.g. in the range of 7.5-20% (w/w), such as in the range of 10-15% (w/w).

8. The animal feed product according to claim 1, wherein the one or more health-enhancing microorganism comprises at least one lactic acid bacterial strain.

9. The animal feed product according to claim 1, wherein the seaweed material is a unicellular alga or a multicellular macroalgae, preferably, the multicellular macroalgae may be selected from brown macroalgae, red macroalgae, and/or green macroalgae, Preferably the multicellular macroalgae is the brown macroalgae and the brown macroalgae may be selected from one or more of kelps, Saccharina latissimi (Laminaria saccharina), Laminaria digitate, Ascophyllum nodosum, Laminaria hyperborean, or a mixture hereof.

10. The animal feed product according to claim 1, wherein the plant material is a proteinaceous plant material, preferably, the proteinaceous plant material is a vegetable material, preferably, the vegetable material is selected from eudicot plants, angiosperm plants, and/or rosid plants, preferably, the vegetable material is selected from Brassicale plants.

11. The animal feed product according to claim 9, wherein the Brassicale plants is selected from the Brassicaceae family or the Cruciferae family.

12. The use of an animal feed product according to claim 1, wherein the animal feed product induces an increased nutritional effect and/or nutritional uptake of a consuming animal wherein the animal feed product is a pig feed product.
